(19) United States
(12) Patent Application Publication
(10) Pub. No.: US 2012/0106159 A1
(43) Pub. Date: May 3, 2012

(54) Lamp Cover

(76) Inventor: Thomas East, Clovis, CA (US)

(21) Appl. No.: 13/279,649

(22) Filed: Oct. 24, 2011

Related U.S. Application Data
(60) Provisional application No. 61/408,685, filed on Nov. 1, 2010.

(51) Int. Cl. F21V 3/00

(52) U.S. Cl. 362/255

(57) ABSTRACT

A lamp cover and method for hiding a non-traditional lamp in a traditional light fixture. An example method may include positioning an opening in an attachment base over a socket of the traditional light fixture. The method may also include connecting the non-traditional lamp in the socket of the traditional light fixture. The method may also include securing an enclosure to the attachment base to entirely cover the non-traditional lamp.

### PRIORITY CLAIM

This application claims the benefit of U.S. Provisional Patent Application No. 61/408,685 filed Nov. 1, 2010 and titled “Reusable decorative enclosure for an exposed compact florescent lamp” of Thomas A. East, which is hereby incorporated by reference as though fully set forth herein.

### BACKGROUND

The compact florescent lamp (CFL) can be used to replace the incandescent lamp. Many consumer CFLs can be used with traditional light fixtures. The CFL bulb offers a higher efficiency alternative to traditional incandescent lamps. Compared to traditional incandescent lamps emitting the same amount of visible light, CFLs use much less electrical power (a fraction) than a traditional incandescent lamp with a similarity rated lumen output. The CFL also generally exhibits a longer life (up to ten times or more) than typical incandescent lamps. Therefore, while the CFL usually costs more to purchase than an incandescent lamp, the consumer can save more money in the cost of electricity over the long run by using a CFL bulb. Recognizing the potential advantages of CFL bulbs, the United States has passed legislation eventually phasing out the incandescent lamp in favor of the CFL.

Despite these advantages, CFLs have several drawbacks. The CFL emits light that is very different from traditional incandescent lamps, and some consumers have complained of “flicker” and the light being “too bright.” More recent versions of the CFL now use phosphor formulations which improve the perceived color of the light emitted by CFLs, and electronic ballasts reduce flicker associated with the older electromagnetic ballasts. Accordingly, many consumer CFLs sold today provide a “soft white” light output that is more comparable to that of traditional incandescent lamps. One drawback which has not been addressed is the unusual shape of the CFL. While not affecting the output, the shape does detract from the appearance of traditional light fixtures. Particularly, light fixtures which are not shaded and/or have exposed bulbs.

### BRIEF DESCRIPTION OF THE DRAWINGS

FIG. 1 is a perspective view of an example lamp cover as it may be used with a non-traditional lamp.

FIG. 2a is a perspective view of an example attachment base of a lamp cover.

FIG. 2b are plan views showing an example attachment base of a lamp cover.

FIG. 3 shows different sizes and shapes of the example lamp covers.

FIG. 4 is a perspective view of another example lamp cover as it may be used with a non-traditional lamp.

FIG. 5 illustrates an example method for hiding a non-traditional lamp in a traditional light fixture.

### DETAILED DESCRIPTION

The unusual shape of the CFL remains an issue for many consumers today. While not affecting the lighting, the helical or tubular shape of most CFLs detracts from the appearance when used in traditional light fixtures. Particularly, light fixtures in which the bulbs are not shaded and/or are exposed. A lamp cover and method for hiding a non-traditional lamp in a traditional light fixture are disclosed which address these issues and offers other advantages, which will be readily apparent to one having ordinary skill in the art after becoming familiar with the teachings herein.

An example lamp cover includes an attachment base having an opening configured to fit a non-traditional lamp. The lamp cover also includes an enclosure to engage with the attachment base and secure the enclosure to the attachment base. Accordingly, the lamp cover is an inexpensive means to add a protective cover over the exposed twist-style CFLs.

An example method may include positioning an opening in an attachment base over a socket of the traditional light fixture. The method may also include connecting the non-traditional lamp in the socket of the traditional light fixture. A decorative enclosure is secured to the attachment base to entirely cover the non-traditional lamp and give the appearance of a traditional light fixture with traditional incandescent bulbs.

Before continuing, it is noted that as used herein, the terms “includes” and “including” mean, but is not limited to, “includes” or “including” and “includes at least” or “including at least.” The term “based on” means “based on” and “based at least in part on.”

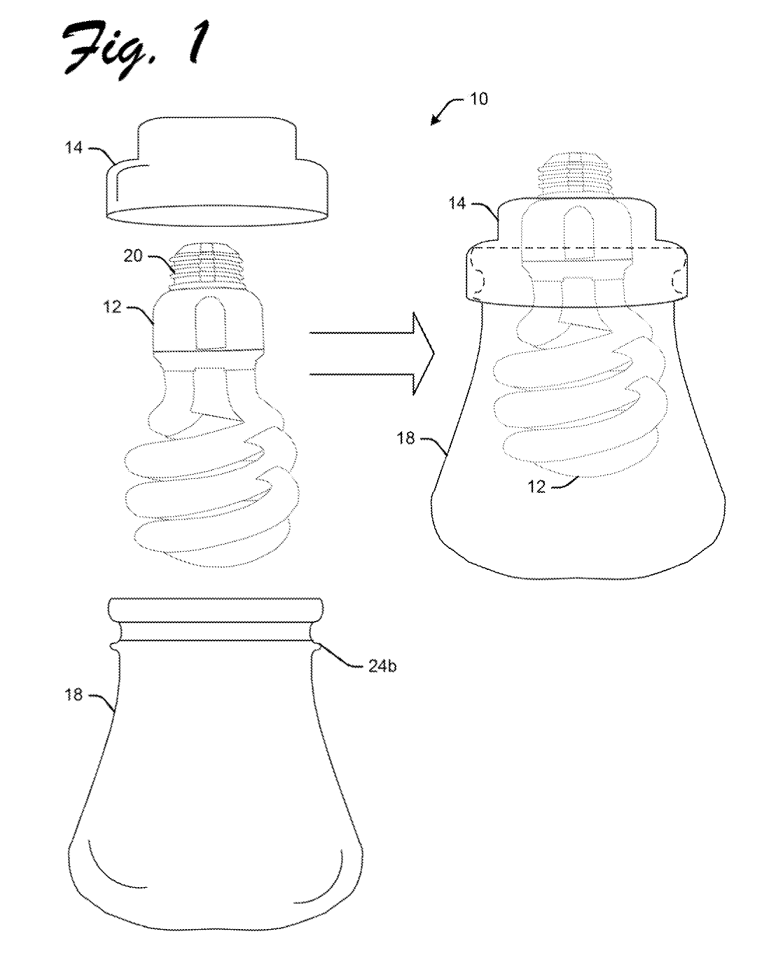

FIG. 1 is a perspective view of an example lamp cover 10 as it may be used with a non-traditional lamp 12. The left hand portion of FIG. 1 shows the lamp cover 10 in an unassembled configuration, and the right hand portion of FIG. 1 shows the lamp cover 10 in an assembled configuration with the non-traditional lamp 12 inside (shown with dashed lines).

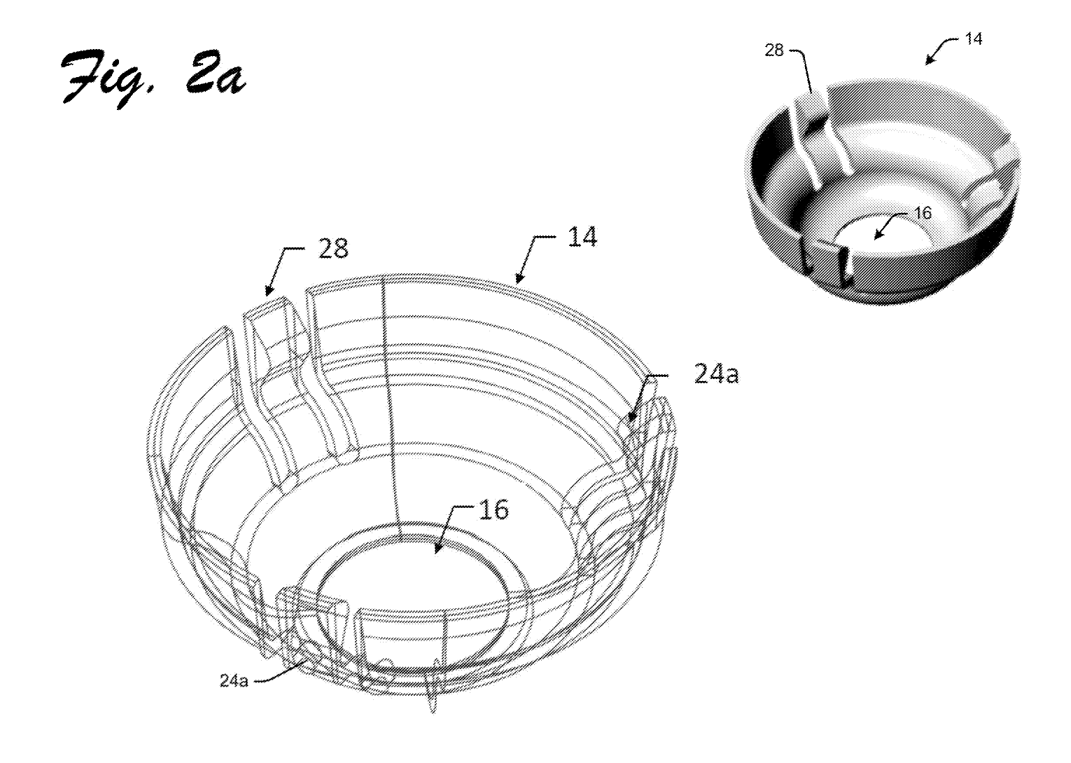

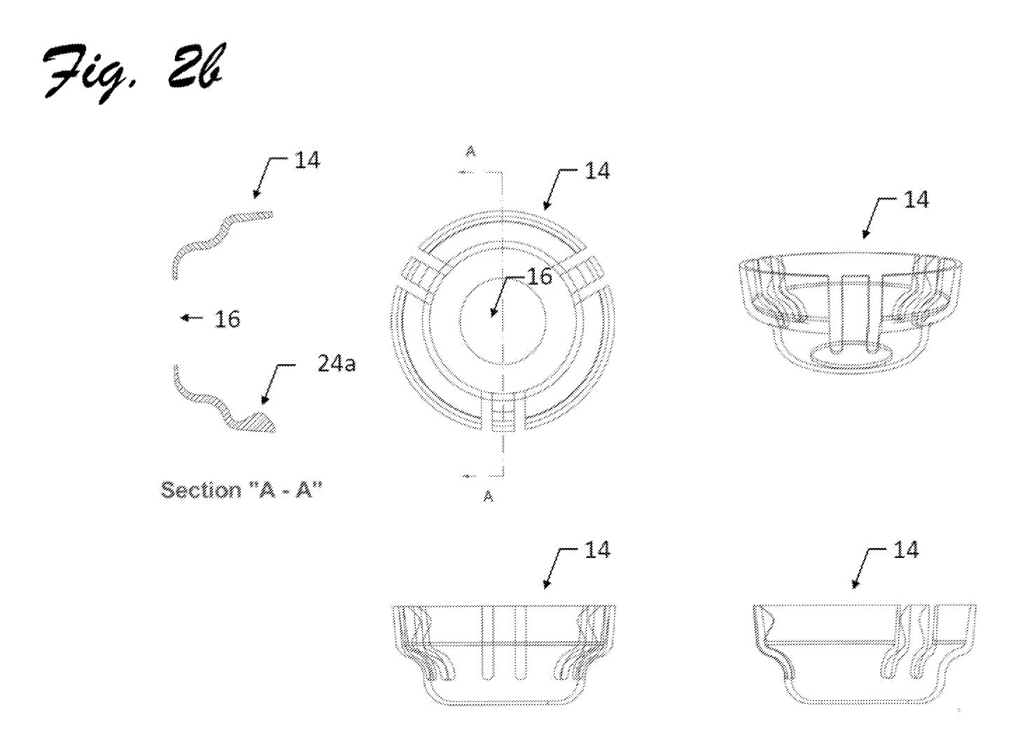

The example lamp cover 10 includes an attachment base 14 having an opening 16 (see FIG. 2a) configured to fit a non-traditional lamp 12, and an enclosure 18 to engage with the attachment base 14 and secure the enclosure 18 to the attachment base 14. The enclosure 18 may engage with the attachment base 14 via a press-fit connection, screw threads, or other fitting.

The lamp cover 10 may also serve as a protective mechanism. For example, the lamp cover 10 may be prevent the CFL from being broken, and/or serve as containment if the CFL does break. As CFL's often include harmful materials such as Mercury, the lamp cover 10 may thus help prevent accidental exposure to the contents of the CFL. The lamp cover 10 may also include a protective coating. CFLs emit the dangerous UV rays similar to the sun (albeit not as intense). The protective coating still enables light to be transmitted through the lamp cover 10, but absorbs and/or blocks harmful UV rays to protect the people near the lighting.

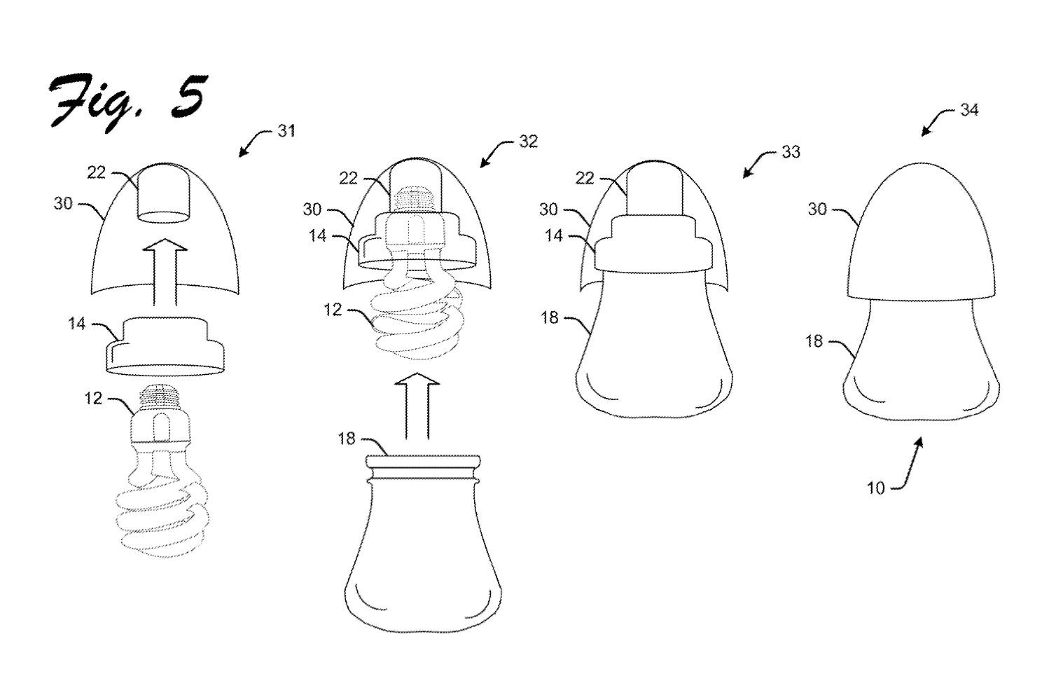

For assembly, the opening 16 in the attachment base 14 receives a socket base 20 of the non-traditional lamp 12. In an example, the attachment base 14 includes a narrower bottom portion to fit inside a light fixture (see FIG. 5), and a wider top portion to connect with the enclosure 18. Accordingly, the attachment base 14 may be secured between the socket base 20 of the non-traditional lamp 12 and the light fixture socket 22 (see FIG. 5) such that there is little or no give or play. That is, the fitting is tight.

FIG. 2a is a perspective view of an example attachment base 14 of a lamp cover 10. FIG. 2b are plan views showing the example attachment base 14 of the lamp cover 10. The detailed engineering drawings show a lip 24a and fingers 28 on the attachment base 14 such that the enclosure 18 can be press fit onto the attachment base 14a and secured to mating lip 24b on the enclosure 18 (see FIG. 1). In an example, the attachment base 14 is assembled on a light fixture before connecting the non-traditional lamp 20 to the light fixture. The enclosure 18 may then be press fit onto the attachment base 14 after the non-traditional lamp 12 is connected to the light fixture.

It is noted that the non-traditional lamp 12 may be a CFL or light emitting diode (LED) lamp. Other non-traditional lamps (not shown) may also be used. Indeed, the lamp cover 10 can even be used with incandescent light bulbs, e.g., to provide a different color light output, size and/or shape for use with an incandescent light bulb.

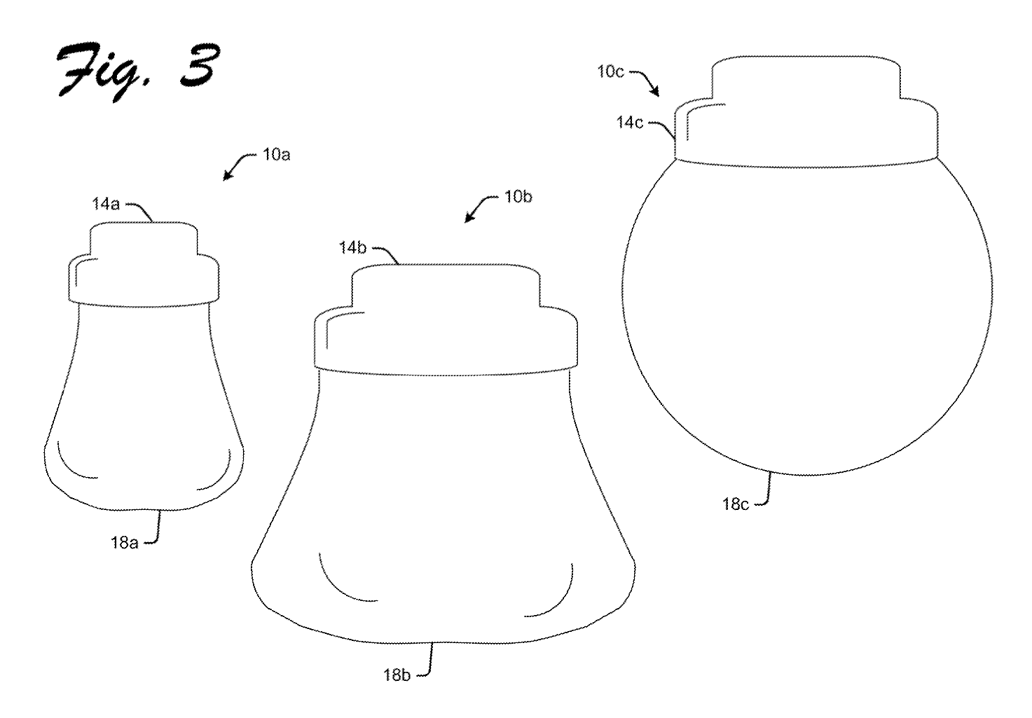

The enclosure 18 may have a size and shape of any type of traditional incandescent light. Accordingly, the lamp cover 10 may be used with any of a wide variety of different types of traditional light fixtures FIG. 3 shows different sizes and shapes of the example lamp covers for use with different light fixtures, such as the lamp cover 10a for use with light fixtures on a fan, lamp cover 10b for use with recessed lighting, and lamp cover 10c for use with vanity light fixtures where the bulbs are fully exposed, to name only a few examples. Other shapes and sizes are also contemplated, for example, novelty shapes, sizes, and colors for holidays and/or other purposes.

As can be seen in each of the examples in FIG. 3, the non-traditional lamp fits entirely within the enclosure and appears as a traditional lamp. The enclosures 18a-c are at least partially transparent, so that light can be emitted to the surrounding environment. Of course, the enclosure 18a-c may be any desired color, and can be frosted or otherwise textured, e.g., to provide the desired lighting effect. For example, the enclosures 18a-c may assist in providing a “soft” lighting effect.

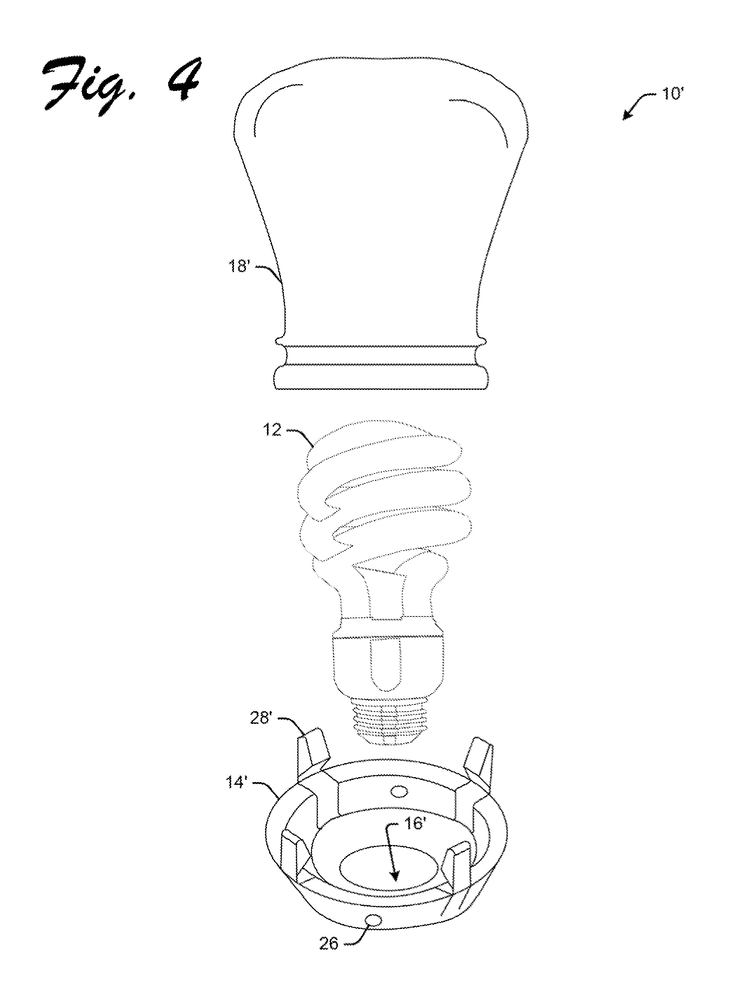

FIG. 4 is a perspective view of another example lamp cover 10′ as it may be used with a non-traditional lamp 12. The enclosure 18′ shown in has a bulb part that is conical, with the larger diameter at the closed end and a smaller diameter that transitions into the neck portion that is cylindrically shaped at the open end. The enclosure 18′ may be manufactured of a rigid material such as plastic or glass. The open end of the enclosure is at the end of the neck part and has an exterior attachment ridge. The attachment base 14′ may have a concave shape that has an opening at the minor end, with four vent holes 26 spaced substantially evenly around the outside perimeter, and a plurality of securing arms 28′ with notches extending upward from edges of the major open end of the shape. The attachment base 14′ may be manufactured of a rigid material such as plastic. In the example shown in FIG. 4, the enclosure 18′ may have an exterior attachment ridge 24b at the open end of the neck that is joined to the notches of the securing arms 28′ of the reusable attachment base 14′. In other examples, the securing arms 28′ may instead be provided on the attachment base 14′, and/or on both the attachment base 14′ and the enclosure 18′.

It can be seen in FIG. 4 that the screw end of an exposed compact fluorescent lamp 12 is inserted through the opening 16 of the reusable enclosure attachment base 14′ so that the securing arms 28′ extend toward the exposed florescent lamp filaments. The compact fluorescent lamp 12 is then screwed into an electrical light socket with the attachment base 14′ secured between the electrical light socket and the compact fluorescent lamp 12. The open end of the reusable decorative enclosure 18′ is then placed over the exposed compact fluorescent lamp 12 until the exterior attachment ridge at the open end of the reusable enclosure snaps into the notches of the four securing arms 28′ of the attachment base 14′.

Before continuing, it should be noted that the examples described above are provided for purposes of illustration, and are not intended to be limiting. Other devices and/or device configurations, including variations to the size, shape, and coloring are also contemplated.

FIG. 5 illustrates an example method for hiding a non-traditional lamp 12 in a traditional light fixture 30. In the first three illustrations (31-33), the light fixture 30 is shown cut-away so that the inside of the fixture 30 is visible (e.g., to see the light fixture socket 22. The method may include positioning an opening 16 (FIGS. 2a and 2b) in an attachment base 14 over a socket 22 of the traditional light fixture 30 as shown by illustration 31, connecting the non-traditional lamp 12 in the socket 22 of the traditional light fixture 30 as shown by illustration 32, and then securing an enclosure 18 to the attachment base 14 to entirely cover the non-traditional lamp 12, as shown by illustration 33. Illustration 34 shows the light fixture 30 without being cut-away as the light may appear in a traditional fan with light fixture.

It can be seen in FIG. 5 that the non-traditional lamp 12 secures the attachment base 14 to the traditional light fixture 30 before the enclosure 18 is secured to the attachment base 14. In addition, the attachment base 14 may be press fit to the enclosure 18 after connecting the non-traditional lamp 12 in the socket 22 of the traditional light fixture 30. Accordingly, there are no screws or other complicated assembly steps needed, making the lamp cover 10 particularly appealing to the average homeowner. The lamp cover 10 can also be readily re-used, for example, after replacing a spent lamp 12 and/or in other light fixtures 30.

The operations shown and described herein are provided to illustrate example implementations. It is noted that the operations are not limited to the ordering shown. Still other operations may also be implemented.

The examples shown and described are provided for purposes of illustration and are not intended to be limiting. Still other examples are also contemplated.

1. A lamp cover comprising:
an attachment base having an opening configured to fit a non-traditional lamp; and
an enclosure to engage with the attachment base and secure the enclosure to the attachment base.

2. The lamp cover of claim 1, wherein a light emitting portion of the non-traditional lamp fits entirely within the enclosure.

3. The lamp cover of claim 1, wherein the enclosure has a size and shape of a traditional incandescent light.

4. The lamp cover of claim 1, wherein the non-traditional lamp is a CFL or LED.

5. The lamp cover of claim 1, wherein the enclosure is a protective mechanism to shield people from contents of a broken non-traditional lamp and UV exposure.

6. The lamp cover of claim 1, wherein the opening in the attachment base receives a socket base of the non-traditional lamp.

7. The lamp cover of claim 6, wherein the opening in the attachment base is secured between the socket base of the non-traditional lamp and a light fixture socket such that there is little or no play.

8. The lamp cover of claim 1, further comprising a lip on the attachment base and a mating lip on the enclosure such that the enclosure is press fit onto the attachment base.

9. The lamp cover of claim 8, wherein the attachment base is assembled on a light fixture before connecting the non-traditional lamp to the light fixture.

10. The lamp cover of claim 9, wherein the enclosure is press fit onto the attachment base after the non-traditional lamp is connected to the light fixture.

11. The lamp cover of claim 1, further comprising at least one attachment arm extending from the attachment base for connecting the enclosure.

12. The lamp cover of claim 1, further comprising at least one attachment arm extending from the enclosure for connecting the attachment base.

13. The lamp cover of claim 1, wherein the attachment base includes a narrower portion to fit inside a light fixture, and a wider portion to connect with the enclosure.

14. A lamp cover comprising:
an attachment means for fitting with a non-traditional lamp in a light fixture; and
an enclosure means for engaging with the attachment means and securing the enclosure means to the attachment means.

15. The lamp cover of claim 14, further comprising means for securing the attachment means between a socket base of the non-traditional lamp and a light fixture socket.

16. The lamp cover of claim 14, further comprising a lip and a mating lip for press fitting the attachment means together with the enclosure means.

17. The lamp cover of claim 14, further comprising at least one attachment arm for connecting the attachment means together with the enclosure means.

18. A method for hiding a non-traditional lamp in a traditional light fixture, the method comprising:
positioning an opening in an attachment base over a socket of the traditional light fixture;
connecting the non-traditional lamp in the socket of the traditional light fixture; and
securing an enclosure to the attachment base to entirely cover the non-traditional lamp.

19. The method of claim 18, wherein the non-traditional lamp secures the attachment base to the traditional light fixture before the enclosure is secured to the attachment base.

20. The method of claim 18, further comprising press fitting the attachment base to the enclosure after connecting the non-traditional lamp in the socket of the traditional light fixture.
